(19) United States
(12) Patent Application Publication
(10) Pub. No.: US 2009/0202683 A1
(43) Pub. Date: Aug. 13, 2009

(54) CONFECTIONS WITH CHEWY, SOUR AND CREAMY ATTRIBUTES, AND METHODS TO MAKE AND USE THE SAME

(76) Inventors: Jennyfer Reed Matteson, East Leroy, MI (US); Richard Norris Flaget, Richland, MI (US)

Correspondence Address: DICKINSON WRIGHT, PLLC;Ste. 2000, 38525 Woodward Ave., Bloomfield Hills, MI, 48304-2970, US

(21) Appl. No.: 12/363,814

(22) Filed: Feb. 2, 2009

Related U.S. Application Data
(60) Provisional application No. 61/027,681, filed on Feb. 11, 2008.

(51) Int. Cl. A23G 3/54

(52) U.S. Cl. 426/103; 426/285

(57) ABSTRACT

The present invention comprises confections having, from interior to exterior: a confection center; a food acid layer; a compound coating layer. The present invention also comprises methods to make the present confections.

### STATEMENT REGARDING FEDERALLY SPONSORED RESEARCH

None

### TECHNICAL FIELD

This invention relates generally to confections having layers, especially those with contrasting flavors and textures in succession. In particular, the invention relates to confections having, from interior to exterior: a confection center; a food acid layer; a compound coating layer; and an exterior shell. In sensory terms, the invention provides a consumer with an unusual and surprising food tasting experience: first, a slight sweet crunch; second, a lingering creamy texture and flavor; third, a significant burst of sour flavor; and fourth, a chewy texture and sweet flavor.

### BACKGROUND OF THE INVENTION

Small-piece confections, such as coated chocolate pieces, yogurt-covered confections, and sour “gummies,” are made by layering components so as to create distinct flavors and textures. In hard-coated chocolate pieces, a chocolate-flavored core is engrossed by a breakable sugar shell so as to both impart a crunchy texture and protect the consumer from unwelcome melting of the core.

Yogurt-covered confections are different, in that the exterior melts relatively quickly and easily. and the interior is chewy and is relatively less melt-able. Often, such compound-coated confections have an thin external layer of heat-tolerant wax or shell which contributes to wider use and appeal. Kellogg's Yogos® are an example of compound-coated confections with an interior chewy core. In that product, a compound coating engrosses a fruit confection center.

Sour “gummies” are produced by forming a sweet, flavored, and chewy core and subsequently dusting the exterior with a food acid, such as citric acid. The gelling ingredient in the core of these products is ordinarily gelatin or pectin. The acidic exterior is applied by use of a wetting agent or food adhesive.

The present invention provides compositions having unexpected and surprising flavor and texture profiles. The invention provides layered compositions having a food acid layer trapped between a chewy core and a compound coating layer. Prior to disclosure of the present invention, those in the art would expect that the inherent moisture in a chewy core would migrate and impair the food acid layer unless it were on the exterior and subject to ambient drying conditions. Those in the art would assume that trapping a food acid layer between a soft core and a fat-based compound coating layer would result in unacceptable sour flavor and/or a brittle core.

### SUMMARY OF THE INVENTION

In general terms, this invention provides surprisingly creamy, sour and chewy confections, and methods to make and use the confections.

In particular, there is provided a confection that comprises, from interior to exterior: a chewy core; a food acid/sour layer; a compound coating layer; and an optional exterior shell. Preferably, such confection comprises a fruit-flavored chewy core.

Also preferable is a confection having a chewy core that has a water activity such that the center remains chewy, and the sour layer remains at least 50% granular (for maximum burst of sour flavor).

The present invention includes methods to make the above confections, taking into consideration the physical parameters necessary to result in both acceptable flavor/texture profiles as well as proper water activities and migration rates. In particular, the present invention provides a method to make a layered confection comprising trapping a granular food acid layer between a chewy core and a compound coating layer. Preferably, the granular food acid layer comprises primarily malic and/or citric acid. However, also preferred are other granular formulations that include other food acids. Embodiments wherein the confection center is a fruit confection are preferred, as are those wherein the piece has an additional hard or semi-hard sugar shell on the exterior.

The most preferable embodiment is shown in FIG. 3 and described in the examples. Those in the art recognize that certain variations would not result in undue experimentation, and those variations are included in the scope of the present invention.

These and other features and advantages of this invention will become more apparent to those skilled in the art from the detailed description of a preferred embodiment.

### BRIEF DESCRIPTION OF THE FIGURES

FIG. 1. Schematic showing a process flow of the present invention;

FIG. 2. Schematic showing details of the process flow of FIG. 1; and

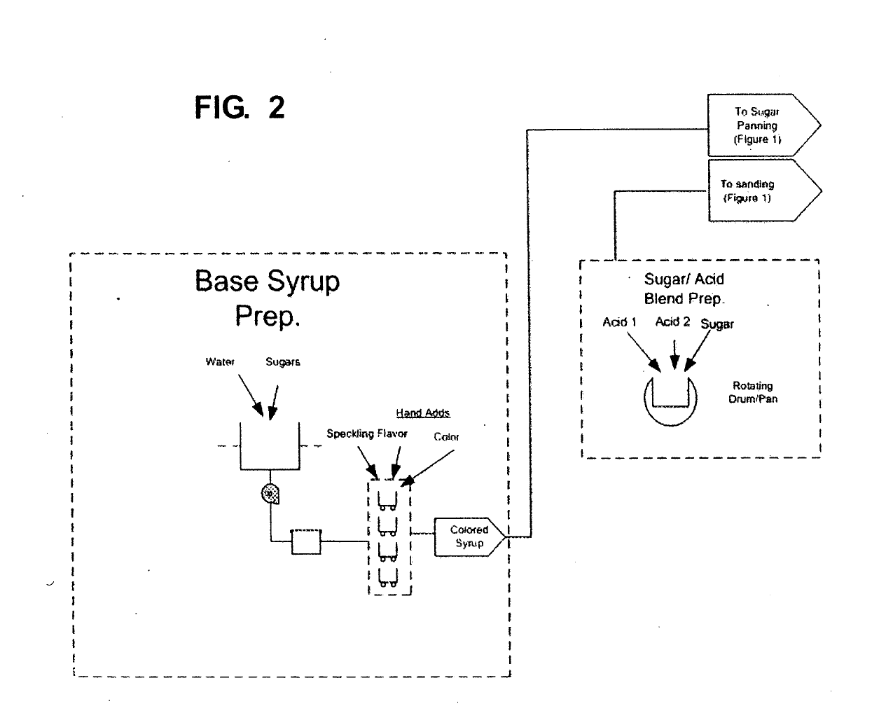

FIG. 3. Schematic of a confection of the present invention.

### DETAILED DESCRIPTION

### Chewy Core.

The present invention comprises, at the center of the confection, a chewy core. The core may be any chewy confection, including jelly beans, fruit snack pieces, gum drops, candy corn pieces, some licorice, gummy candies and any others that are typically made by forming a base slurry into pieces using a starch molding process, or natural dried fruit.

Typically, the base slurry comprises sweeteners, gelling agents or hydrocolloids, flavors, acidulants, and optional ingredients such as vitamins, fortificants, oils and other components.

The sweeteners can comprise one or more monosaccharides or disaccharides. Examples include sugar, sucrose, invert sugar, dextrose, lactose, honey, malt syrup, malt syrup solids, maltose, fructose, granular fructose, maple syrup, rice syrup, rice syrup solids, sorghum syrup, refiners syrup, corn syrup, corn syrup solids, high fructose corn syrup, molasses, or combinations thereof. In addition, artificial sweeteners can be used such as acesulfame K, aspartame, sucralose, d-tagatose, and combinations thereof. The amount of sweetener can range from 40 to 80% by weight and more preferably from 50 to 70% by weight based on the total weight of the chewy core. The desired final solids content of the starch molded piece after formation and drying is generally from about 80 to 90% and the amount of sweetener can be adjusted to achieve these solids.

Suitable gelling agents and hydrocolloids can be selected by one of ordinary skill in the art. Examples include gums, carrageenan, gelatin, pectin, high methoxy pectin, alginates, and agar. One of ordinary skill in the art can select a suitable gelling agent or hydrocolloid depending on the desired final texture of the starch molded piece. In the present invention a pectin is preferred and more preferably a high methoxy pectin is used.

In the present invention, a colloid batch and a puree batch are formed and combined with corn syrup and sugar to form a base slurry. The colloid batch preferably comprises a solution of the gelling agent in water at a level of from 5 to 15% by weight of the gelling agent, more preferably from 7 to 12% of the gelling agent based on the total weight of the colloid batch. The colloid batch is held at a temperature of 170 to 190° F. The puree batch preferably comprises water, fruit puree and/or high fructose corn syrup or other sweeteners, thin boiling starch, and sodium citrate. It is held at a temperature of from 65 to 75° F. Preferably the fruit puree has a Brix of from 10 to 45, more preferably from 25 to 40. The puree batch can include a plurality of fruit purees. The fruit puree can comprise either a typical fruit puree, a fruit juice, or a fruit powder. The puree batch preferably comprises from 30 to 40% by weight water, from 0 to 40% by weight fruit puree, from 0 to 40% by weight high fructose corn syrup, from 25 to 35% by weight thin boiling starch and from 0.0 to 2.0% by weight sodium citrate.

In a mixing kettle from 25 to 40% by weight of additional corn syrup is combined with from 15 to 40% by weight of fine granulated sugar, from 10 to 15% by weight of the colloid batch and from 20 to 30% by weight of the puree batch to form the base slurry. Preferably the corn syrup is approximately 42 DE corn syrup, however, as would be understood by one of ordinary skill in the art other DE corn syrups could be used. The base slurry components are completely mixed and held at 130 to 150° F. in a holding tank.

The base slurry is then cooked to bring the Brix to from 70 to 85 Brix, more preferably to a Brix of from 75 to 80. In one embodiment the base slurry is passed through a coil cooker and heated to a temperature of from 250 to 325° F. to cook it. Other cooking methods could be used as will be understood by one of ordinary skill in the art. The cooked base slurry is preferably subjected to vacuum to further increase the Brix into the desired range. The cooked base slurry is held at approximately 200° F. until used.

An acidulant solution is preferably added along with color and flavor to the cooked base slurry just prior to deposition in the starch molds. Preferably the acidulant solution comprises ascorbic acid present in an amount of from 15 to 20% by weight, citric acid present in an amount of from 10 to 20% by weight, and malic acid present in an amount of from 5 to 10% by weight with the remainder comprising water. As would be understood by one of ordinary skill in the art other edible acids could be used in place of or in addition to those listed. Preferably 95 to 97% by weight of cooked base slurry is combined with from 2 to 3% by weight of the acidulant solution and the remainder comprises flavors and colors. The acidulant solution is used to preferably bring the pH of the base slurry to from 2.6 to 3.2. One of ordinary skill in the art would have no difficulty selecting suitable colors and flavors. The combined mixture is then deposited into starch molds, preferably using a Mogul starch molding machine. Such starch molding machines are well known by those of ordinary skill in the art. Preferably from 0.3 to 3 grams of the base slurry is deposited into each mold cavity.

The starch trays with deposited base slurry are transferred to a drying room where there are held for 12 to 48 hours. Preferably, the trays are first held at a temperature of from 130 to 150° F. for from 10 to 15 hours and then cooled to 70 to 80° F. and held at that temperature for from 6 to 12 hours. The gelled starch molded food pieces are then removed from the trays, the starch is recycled.

The water activity of the chewy interior at this stage is approximately 0.55 to 0.7.

### Sour Layer.

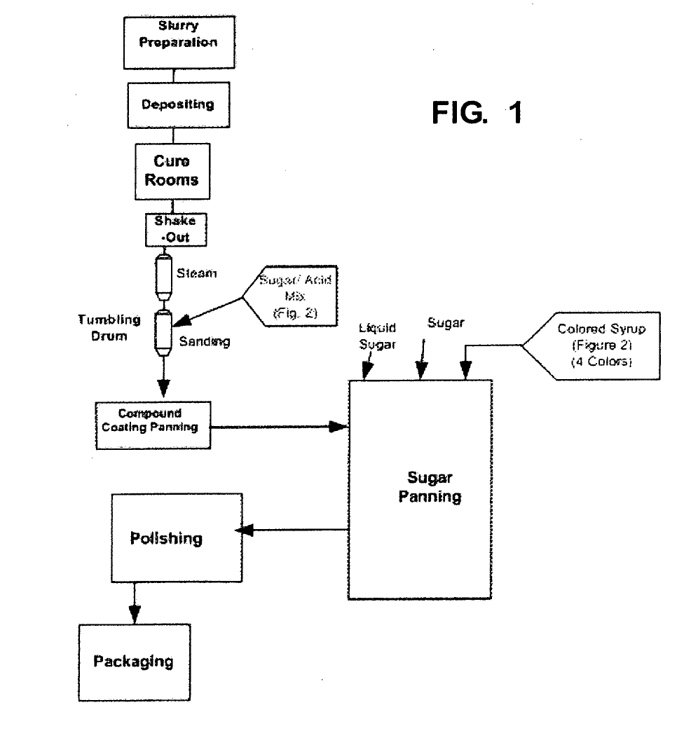

The second layer of the present invention, detailing from the interior to the exterior, and according to FIG. 1, is a sour layer, comprising at least one food acid.

The gelled starch molded food pieces are placed on a conveyer, and passed through a first rotating, ridged screen drum that is within a second ridged drum. The second ridged drum carries a granular food acid/sugar blend along the ridges such that the blend deposits on the food pieces as they rotate within the first drum. The first drum comprises some sections of non-ridged surfaces so that the pieces and food acid/sugar blend pool and mingle prior to being tossed by the rotating ridges.

Steam is injected concurrent with introduction of the food pieces, immediately preceding the food pieces entering the sanding drum, so as to temporarily dissolve a thin layer of the food acid/sugar blend on the surface of the food piece. During tumbling, the thin dissolved layer subsequently dries and re-crystallizes, and the process repeats during tumbling to form an acceptable sour layer. The steam can be adjusted as necessary to adhere at least 8% of the food acid/sugar blend on the surface of each core. Preferably, 10% or greater of the acid formulation is incorporated. In other terms, Preferably the food acid layer is mixed with the food pieces in a weight ratio of from 1:9 to 1:8.

The food acid/sugar blend may be comprised of any food acid, or any combination of food acids, and preferably also contains ingredients that optimize processing. Preferred food acids are: malic acid, citric acid, ascorbic acid, or some combination of the three. Baker's sugar is most preferably used, although any grade of sugar is acceptable.

### Compound Coating.

The third layer of the present invention, detailing from the interior to the exterior, and according to FIG. 1, is a compound coating layer, comprising at least one fat.

The food pieces with a sour layer are transferred to a confectionary coating panning apparatus and, in one embodiment, pan coated with a yogurt flavored compound coating in a weight ratio of 60 to 80% food pieces to 20 to 40% yogurt compound coating solution. Preferably during coating process the yogurt coating is kept a temperature of from 110 to 114° F. so that it is flowable. In a batch panning process, 170 pounds of compound coating is drizzled into the pan over the course of 1 to 1.5 hours, or 1-2 pounds per minute, so as to result in a smooth finish. The food pieces of the present invention can be coated with any compound coating flavor, such as chocolate, strawberry, vanilla, peanut butter, or any combination of these.

### Optional Exterior Coat.

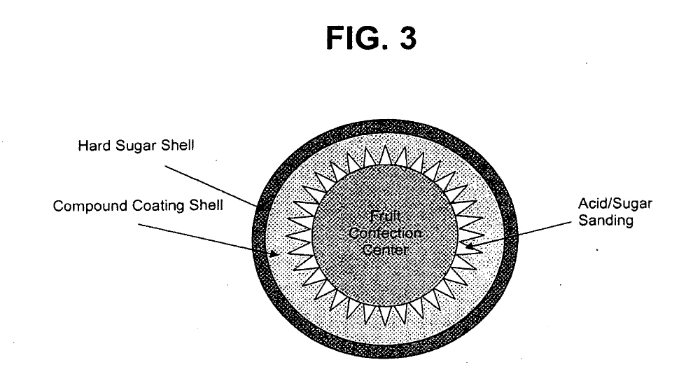

The optional fourth layer of the present invention, detailing from the interior to the exterior, and according to FIG. 3, is a protective exterior that also functions as a flavor and color carrier.

Preferably, the present invention also comprises an additional coating, comprising alternating layers of engrossing syrup and drying sugar, on the surface of the compound coating.

Preferably, the engrossing syrup has a weight ratio of corn syrup to liquid sugar of from 3.75:1 to 6:1. Preferably the engrossing syrup also includes 2 to 20% by weight of a film forming starch or starch derivative, such as a modified corn starch, a tapioca dextrin or a maize dextrin and from 10 to 20% by weight of water in addition to the corn syrup, starch and liquid sugar. The engrossing syrup can also include additional color agents at levels of from 0.1 to 3% by weight. The engrossing syrup can optionally include additional flavors at levels up to 5% by weight. Preferably the engrossing syrup of the present invention has a solids level of from 65 to 72%. The engrossing syrup is applied at temperatures of less than 100° F., preferably at temperatures of less than 80° F., thus the temperature sensitive coating remains attached to the food pieces and is stable.

The present process preferably comprises using only confectioners sugar as the drying sugar. The present process produces a smooth, much thinner and softer coating.

This coating is much thinner than a typical panning process coating, which usually is from 33 to 50% by weight of the final piece. Preferably the coating is added in at least six repetitions of alternating an engrossing syrup coating followed by a drying sugar coating.

In one embodiment, food glitter is added after the fourth or greater repetition. Such glitter is added at 0.5 to 4%, preferably approximately 2% by weight of the end product. The glitter is surprisingly stable if added at this stage, and the color does not bleed as would ordinarily be expected.

Preferably the final coated piece comprises 50 to 60% food pieces, 20 to 30% compound coating, 10 to 30% engrossing syrup/drying sugar.

As a final optional step the coated pieces can be polished and waxed using approximately 0.044% by weight of a carnauba wax as is known in the art. Optionally an air stream drying step can be used during the last engrossing syrup and drying sugar coating and also during the waxing and polishing steps. The polished and waxed pieces are then packaged, preferably in high moisture barrier packaging to prevent the pieces from exposure to moisture during storage.

### EXAMPLES

### Example 1

### Preparing a Chewy Core

First, a colloid batch of pectin and water, at a ratio of 90.9% water, and 9.09% pectin was agitated in a food grade vessel at approximately 180° F. Also, a puree batch made from 35.77% water, 32.58% apple pure concentrate (38 Brix), 1.08 sodium citrate, and 30.55% Starch (Modified Corn HI—Set 32) was made by mixing the ingredients and holding at approximately 70° F.

A cooked base was then made, using 13.95% of the colloid batch, 24.69 of the puree batch, 28.84% fine granulated sugar, and 32.50% 42 DE corn syrup by mixing the ingredients in a mixing kettle, and holding the cooked base at approximately 140° F. The base is then cooked to a Brix of approximately 80, by passing through a coil cooker.

An acid solution of 6.41% malic acid, 13.93% citric acid anhydrous (fine granulated), 18.53% ascorbic acid (vitamin C), and 61.13% water was made by mixing all ingredients together so as to be thoroughly combined.

The chewy center of 0.23% fruit flavor, 96.75% cooked base, and 2.75% acid solution was mixed together and the final pH adjusted so as to be in the range of from 2.6 to 3.2. This forms the deposition base slurry. The deposition base slurry is deposited into starch molds using approximately 0.4 grams for each deposit.

The starch trays with deposits are transferred to a hot room and held at approximately 140° F. for about 12 hours and then held at approximately 75° F. for 6 to 12 hours.

### Example 2

### Food Acid/Sugar Blend

The dried food pieces are de-molded, steamed, and tumbled in a food drum with a either a low acid formulation or a high acid formulation at a ratio of 1 part food acid formulation to 9 parts food pieces. The low acid formulation used is described in Formula A, and the high acid formula is described in Formula B.

Formula A: Low Acid Formulation

| Ingredient | Percent by Weight |
|---|---|
| Sugar, Baker's Special | 7.00 |
| Citric Acid Anhydrous, Fine Granulated | 1.50 |
| Malic Acid | 1.50 |
| Chewy Core | 90.00 |
| Total | 100.00 (appx.) |

Formula B: High Acid Formulation

| Ingredient | Percent by Weight |
|---|---|
| Citric Acid Anhydrous, Fine Granulated | 6.00 |
| Sugar, Baker's Special | 4.00 |
| Chewy Core | 90.00 |
| Total | 100.00 (appx.) |

### Example 3

### Compound Coating

The food acid layered food pieces are than coated with a yogurt based compound coating using a panning process. The yogurt coating comprises 97% by weight of bulk yogurt coating and 3% by weight liquid sugar. The final ratio of sanded food pieces to yogurt coating is 66% by weight food pieces and 34% by weight yogurt coating. The yogurt coating is kept at approximately 112° F. The coating process requires approximately 1.5 to 2 hours.

Formula G: Yogurt Coated Center

| Ingredient | Percent by Weight |
|---|---|
| White Yogurt Compound Coating | 33.31 |
| Liquid Sugar | 0.06 |
| Chewy Core (low or high acid) | 66.62 |
| Total | 100.00 (appx.) |

### Example 4

### Exterior Shell

An engrossing syrup was created comprising 50.50% by weight corn syrup 42 DE, 14.00% by weight tapioca dextrin, 21.50% by weight water, 12.00% by weight liquid sugar. The drying sugar used was confectioner's sugar. The panning process was conducted at a room temperature of 20 to 25° C. The panning process is to alternate coatings of engrossing syrup with confectioners sugar as the drying sugar, for at least six repetitions.

The end product comprised approximately 80% coated chewy core by weight, approximately 3.3% engrossing syrup by weight, 16.14% drying sugar, by weight, approximately 0.25% food color by weight, and 0.07 to 3.3% flavor solution by weight, with some pieces having 0.26% food glitter applied during the fourth and/or fifth engrossing syrup/sugar repetition.

The food pieces are then sealed, waxed and polished with 0.044% by weight of a carnauba wax.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A confection comprising a first chewy core, a second layer comprising at least one food acid, and a third layer comprising a compound coating, wherein said second layer is located between said chewy core and said compound coating.

2. A confection of claim 1, wherein said chewy core is selected from the group consisting of: jelly bean, fruit snack piece, gum drop, candy corn piece, chewy licorice piece, gummy candy, and natural dried fruit piece.

3. A confection of claim 1, wherein said chewy core is made via introduction of a base slurry into a starch mold.

4. A confection of claim 1, wherein said chewy core is 30 to 50% of the total weight.

5. A confection of claim 1, wherein said second layer further comprises sugar.

6. A confection of claim 3, wherein said food acid selected from the group consisting of: malic acid, citric acid, ascorbic acid.

7. A confection of claim 1, wherein said second layer is 10 to 20% of the total weight.

8. A confection of claim 1, wherein said second layer is at least 50% granular.

9. A confection of claim 1, wherein said compound coating is a flavor selected from the group consisting of: chocolate, strawberry, vanilla, and peanut butter.

10. A confection of claim 1, which further comprises a finishing coat on said compound coating.

11. A confection of claim 10, wherein said finishing coat is thin and soft.

12. A confection of claim 1, wherein said finishing coat is 10 to 30% of the total weight.

13. A confection of claim 12, wherein said finishing coat further comprises food glitter.

14. A confection of claim 9, which further comprises a wax on said finishing coat.

15. A confection of claim 9, wherein said wax coat is 0.01 to 0.1% of the total weight.

16. A confection comprising a 30 to 50% gummy core, 10 to 20% food acid layer, and 30 to 40% compound coating, wherein said food acid layer is located between the gummy core and the compound coating.

17. A confection of claim 16, wherein said compound coating is yogurt-flavored.

18. A confection of claim 17, which further comprises a thin and soft engrossing syrup coating on the exterior of the compound coating.

19. A method to make a confection, comprising the steps of: tumbling at least one chewy core with a food acid/sugar blend in a container; introducing intermittent steam blasts into said container so as to adhere at least 10% food acid/sugar blend to said chewy core, so as to result in a sour, chewy confection having a ratio of at least 9 parts chewy center and 1 part food acid/sugar blend; and introducing compound coating to said sour, chewy confection at least at ratio of 3 parts sour chewy confection and 2 parts compound coating.

20. A method of claim 17, which further comprises the step of: introducing an engrossing syrup/drying sugar to said compound coated sour chewy confection so that the resulting confection comprises: 50 to 60% sour chewy confection; 20 to 30% compound coating; and 10 to 30% engrossing syrup/drying sugar.
